(19) United States
(12) Patent Application Publication
(10) Pub. No.: US 2009/0148060 A1
(43) Pub. Date: Jun. 11, 2009

(54) IMAGE PROCESSING APPARATUS AND METHOD THEREOF

(75) Inventors: Mayumi Yuasa, Tokyo (JP); Osamu Yamaguchi, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 12/275,824

(22) Filed: Nov. 21, 2008

(30) Foreign Application Priority Data
Nov. 22, 2007 (JP) 2007-303084

(51) Int. Cl. G06K 9/40; G06T 15/10

(52) U.S. Cl. 382/260; 345/427

(57) ABSTRACT

An image processing apparatus applies a separability filter to respective positions of an inputted image including a linear object, calculates separability of the respective positions, generates a separability map as a set of the separability of the respective positions, applies distance transform or thinning process to the separability map to generate a skeleton image in which the linear object is displayed, and outputs the skeleton image.

### CROSS-REFERENCE TO RELATED APPLICATIONS

This application is based upon and claims the benefit of priority from the prior Japanese Patent Application No. 2007-303084, filed on Nov. 22, 2007; the entire contents of which are incorporated herein by reference.

### FIELD OF THE INVENTION

The present invention relates to an image processing apparatus configured to extract a linear object such as a vein and a method thereof.

### DESCRIPTION OF THE BACKGROUND

Recently, individual authentication using vein of a finger or a palm is carried out in automatic teller machines (ATM) or the like in banks. Images of vein are picked up by the irradiation of an infrared ray in many cases.

In the related art, some of the image processing apparatuses configured to extract vein portion from those images employs a curvature of image profile as disclosed in JP-A-2005-71118 (kokai).

However, with the vertical or lateral profiles as shown in JP-A-2005-71118, it is difficult to extract the vein which appears as curves in arbitrary directions irrespective of the direction.

There is a case in which the result is incorrect due to unevenness of the irradiation of the infrared ray or the influence of noises.

In this manner, the related art has a problem such that it is difficult to extract the vein which appears as curves in the arbitrary directions irrespective of the direction. It also has a problem such that the result might be incorrect due to the influence of noises.

### SUMMARY

In view of such problems as described above, it is an object of the invention to provide an image processing apparatus which enables stable extraction of linear objects such as vein and a method thereof.

According to embodiments of the invention, there is provided an image processing apparatus including a map generating unit configured to apply a separability filter to respective positions of an image including an inputted linear object, calculate separability of the respective positions, and generating a separability map as a set of the separability of the respective positions; and an image generating unit configured to apply distance transform or thinning process to the separability map and generate a skeleton image in which the linear object is displayed; and an output unit configured to output the skeleton image.

According to the present invention, even when the distribution of the image intensity is partly different, the linear object can be extracted by using the separability filter.

### BRIEF DESCRIPTION OF THE DRAWINGS

FIG. 1 is a block diagram showing an image processing apparatus according to a first embodiment of the invention;

FIG. 2 is a flowchart showing the operation of the image processing apparatus;

FIG. 3 is an explanatory drawing of a circular separability filter;

FIG. 4 is a drawing showing an example of a result of processing;

FIG. 5 is a block diagram of the image processing apparatus according to a second embodiment;

FIG. 6 is a flowchart showing the operation of the image processing apparatus;

FIG. 7 is a drawing showing an example of a result of processing;

FIG. 8 is a drawing showing an example of a result of processing according to a third embodiment;

FIG. 9 is a drawing showing an example of a result of processing according to a fourth embodiment;

### DETAILED DESCRIPTION OF THE INVENTION

### First Embodiment

Referring now to FIG. 1 to FIG. 4, an image processing apparatus 10 according to a first embodiment of the invention will be described. The image processing apparatus 10 in the first embodiment extracts vein portion as a linear object from an infrared ray image picked up by irradiating, for example, a finger or a hand with an infrared ray.

FIG. 1 is a block diagram showing the image processing apparatus 10 according to the first embodiment. The image processing apparatus 10 includes an image inputting unit 12 configured to enter an infrared ray image including a linear object, a map generating unit 14 configured to generate a separability map, an image generating unit 16 configured to extract a skeleton portion of the image from the separability map, and an output unit 18 configured to output a result.

Respective portions 12 to 18 may also be realized by programs stored in a computer readable medium.

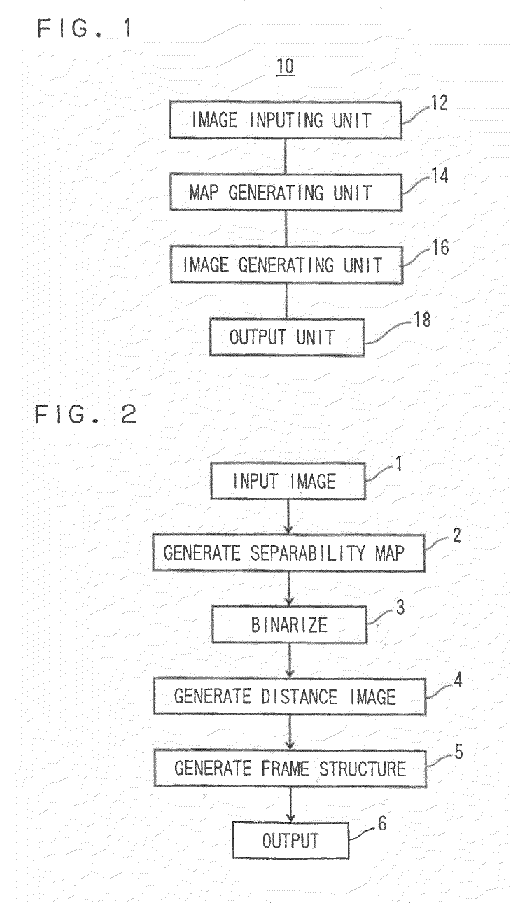

Referring now to FIG. 1 and FIG. 2, the operation of the image processing apparatus 10 will be described. FIG. 2 is a flowchart showing the operation of the image processing apparatus 10.

In Step 1, the image inputting unit 12 inputs an infrared ray image including a linear object such as vein.

In Step 2, the map generating unit 14 generates the separability map by applying a circular separability filter to the inputted image.

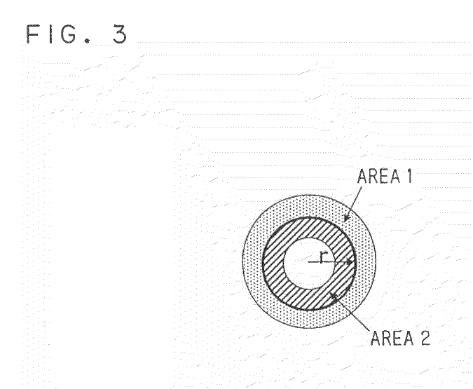

The “circular separability filter” calculates the separability of respective points in the image on the basis of the circular filter shown in FIG. 3.

The “separability” is an index which represents the degree of separation between two areas, and is a value calculated by Expression 1.

$$η = \frac{{σ}_{b}^{2}}{{σ}_{T}^{2}} {σ}_{b}^{2} = {{n}_{1} ( {\overline{P}}_{1} - {\overline{P}}_{m} )}^{2} + {{n}_{2} ( {\overline{P}}_{2} - {\overline{P}}_{m} )}^{2} {σ}_{T}^{2} = {\sum }_{i = 1}^{N} {( {\overline{P}}_{i} - {\overline{P}}_{m} )}^{2} \qquad ( 1 )$$

where P₁ is the image intensity at a pixel i, P̅₁̅, P̅₂̅, P̅ₘ̅ are values of average image intensity at areas 1, 2, and 1+2, n₁, n₂ N represent number of pixels in the respective areas.

Generally, as the image intensity Pi, the pixel value in a grey image is used. In the circular separability filter shown in FIG. 3, the areas 1 and 2 correspond to the area outside (area 1 in FIG. 3) and inside (area 2 in FIG. 3) of a circle having a radius of r.

The map generating unit 14 is able to extract the linear object of a circular shape by the circular separability filter and, in the same manner, is able to extract an elongated linear object having the same width as the radius r. Here, as the radius r, which is a parameter showing the scale, an arbitrary value corresponding to the linear object (vein) which is desired to be extracted is used.

However, the radius r does not have to be a single radius, and may be a plurality of radii. In such a case, the separability maps are generated correspondingly.

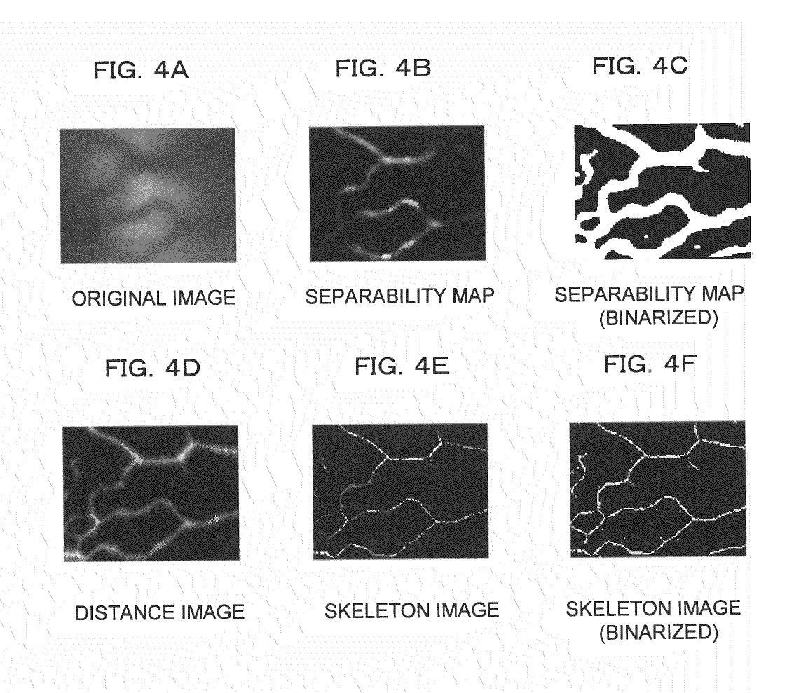

The examples of the separability map are as shown in FIG. 4.

Generally, the portion of the vein is darker than the background area in many cases. Therefore, the difference of the average values of the two areas of the separability filter may be added as in Expression 2. However, the value of α is a predetermined constant.

η′=η+α( P̅₁̅− P̅₂̅) (2)

In Step 3, the image generating unit 16 binarizes the separability map generated by the map generating unit 14 with a predetermined threshold value to generate a binarized image.

In Step 4, the image generating unit 16 performs distance transform with respect to the binarized image.

The term “distance transform” means an operation to provide areas having a pixel value of 1 in the binarized image with the distance from the background (where the pixel value is zero) as a pixel value. The distance includes a four-neighbor distance, an eight-neighbor distance, and a Euclidean distance, and the case of the four-neighbor distance is taken as an example for description.

The four-neighbor distance transform is defined by Expression 3 with respect to an input image {fᵢⱼ}. It is an operation to obtain an output image {dᵢⱼ}. In other words, it is transform to provide the respective pixels (i, j) the four-neighbor distance from the background (where the pixel value is zero) which is nearest from the corresponding point.

dᵢⱼ=min {|i−u|+|j−v|;fᵤᵥ₌₀} (3)

In Step 5, the image generating unit 16 generates a skeleton image from the distance-transformed image dᵢⱼ.

The term “skeleton” is a set of pixels which satisfies Expression (4) with respect to the distance-transformed image dᵢⱼ. The “skeleton image” defined here is those obtained by providing the pixels in the skeleton portion with the value of distance-transformed image dᵢⱼ.

dᵢⱼ=min {|i−u|+|j−v|;fᵤᵥ₌₀} (4)

The skeleton image may be those obtained by providing with a specific value other than zero instead of the value of distance-transformed image dᵢⱼ.

In Step 6, the output unit 18 outputs the generated skeleton image as a result.

The skeleton image outputted in this manner is compared, for example, with the skeleton images of the individuals registered in advance for individual authentication by ATM in the banks or the like.

In this manner, according to the image processing apparatus 10 in this embodiment, the vein portion can be stably extracted from the image including the vein by combining the circular separability filter with the process of generating the skeleton.

The separability filter is able to extract edges according to the shape of the filter using a normalized value, that is, the difference of image intensity. Therefore, extraction of edges is achieved without problem even when lighting is different from part to part at the time of picking up the image.

Since the shape of the separability filter is circle and is rotation symmetry, extraction is achieved in any directions unlike with the processing of profiles.

### Second Embodiment

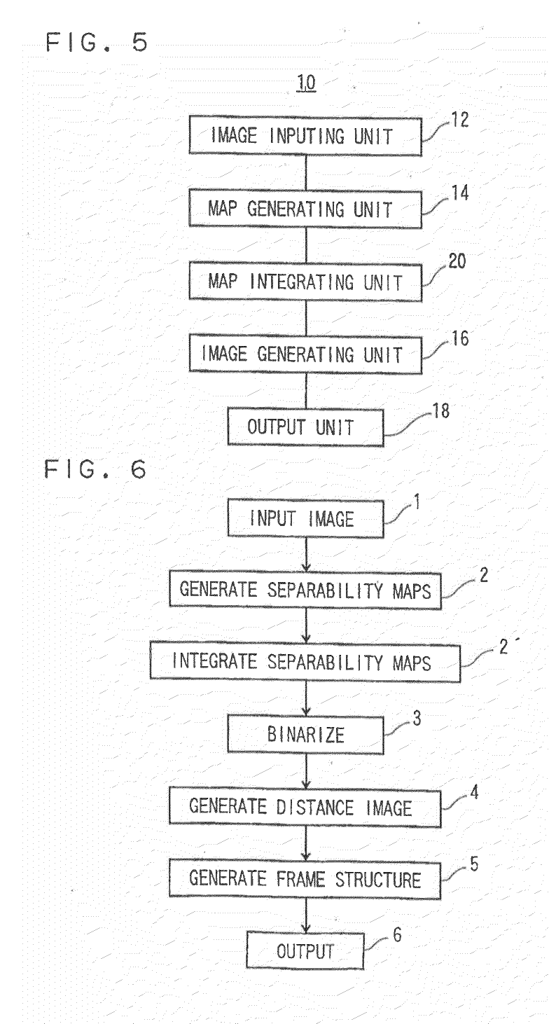

Referring now to FIG. 5 to FIG. 7, the image processing apparatus 10 according to a second embodiment of the invention will be described.

The image processing apparatus 10 in the second embodiment generates a plurality of separability map using a plurality of types of circular separability filter having different radii and integrates the same.

FIG. 5 is a block diagram showing the image processing apparatus 10 according to the second embodiment. FIG. 6 is a flowchart showing the operation of the image processing apparatus 10 according to the second embodiment.

The image inputting unit 12, the image generating unit 16, and the output unit 18 of the image processing apparatus 10 in the second embodiment are the same as those in the first embodiment.

The operation of the map generating unit 14 and a map integrating unit 20 which are different from the first embodiment will be described below.

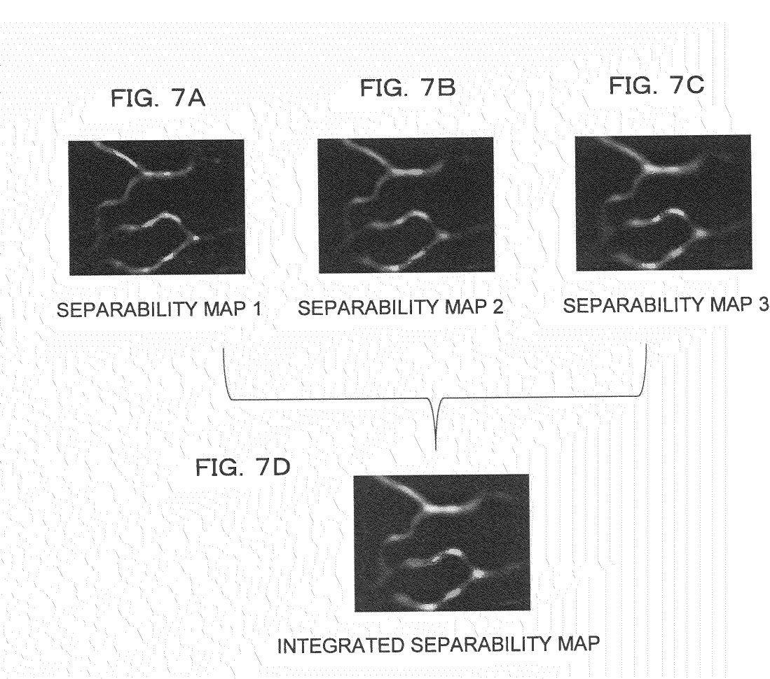

The map generating unit 14 generates a plurality of separability maps using a plurality of types of circular separability filter having predetermined different radii. Examples of three types of generated separability maps are shown in FIG. 7.

The map integrating unit 20 generates one separability map by integrating the plurality of separability maps generated by the map generating unit 14 (Step 2′ in FIG. 6).

In this embodiment, the separability at the same positions in the respective separability maps are compared to obtain the maximum value of the separability, and the maximum value is employed as a new separability of the separability map. An example of integrated separability map is shown in FIG. 7. Although the maximum value is used at the time of integration, integration may be performed by an arbitrary processing such as the average value or the like.

According to the second embodiment, stable extraction is achieved even when the thickness of the linear objet is different from point to point as in the case of the vein by using the circular separability filters having the plurality of types of radii.

Even the linear object having the width which cannot be obtained by a single radius is also extracted by generating the skeleton image on the basis of the separability maps of the plurality of different radii.

### Third Embodiment

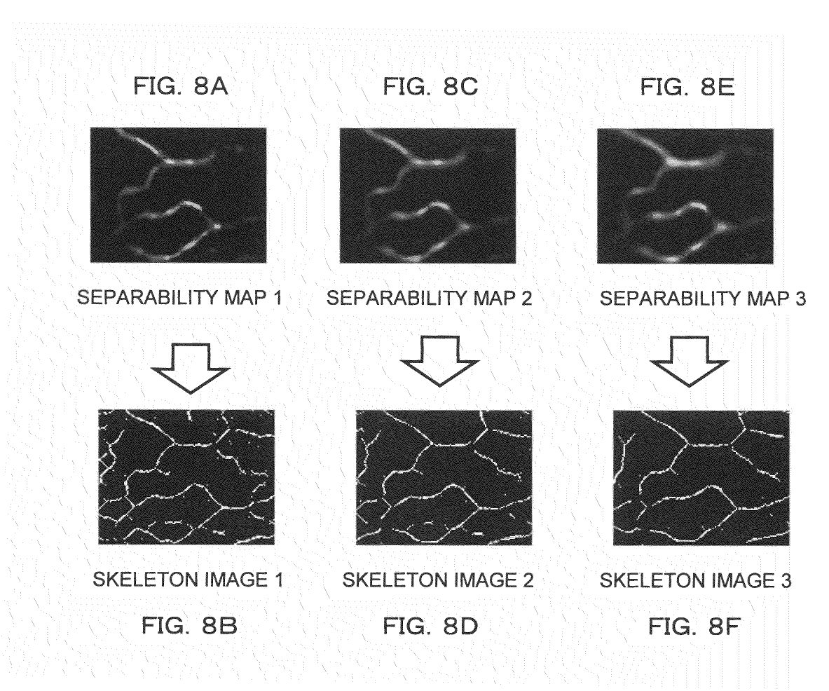

Referring now to FIG. 8, the image processing apparatus 10 according to a third embodiment of the invention will be described.

The image processing apparatus 10 in the second embodiment generates a plurality of separability maps using a plurality of types of circular separability filter having different radii and generates the skeleton images corresponding to the respective separability maps.

The configuration of the image processing apparatus 10 in the third embodiment is the same as that of the image processing apparatus 10 in the first embodiment.

FIG. 8 shows examples of skeleton images generated from the separability maps of the plurality of radii.

The output unit 18 outputs all the skeleton images, respectively. These images may be integrated. In order to integrate these images, there is a method of outputting a maximum value as the integration of the separability maps in the second embodiment.

As described above, even the linear object having the width which cannot be obtained by a single radius is also extracted by generating the skeleton images on the basis of the separability maps of the plurality of different radii as in the image processing apparatus 10 in the third embodiment.

### Fourth Embodiment

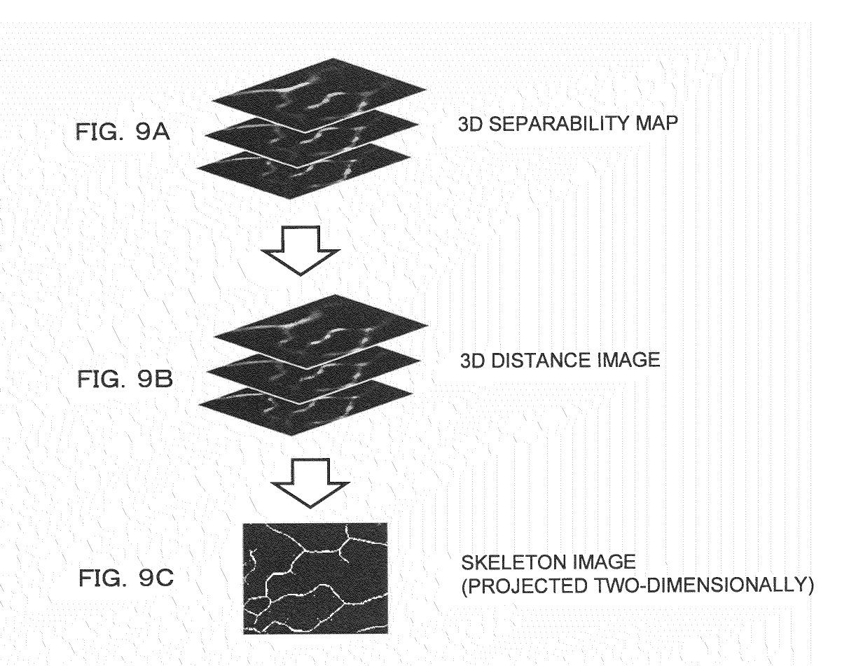

Referring now to FIG. 9, the image processing apparatus 10 according to a fourth embodiment of the invention will be described. The configuration of the image processing apparatus 10 in the fourth embodiment is the same as that of the image processing apparatus 10 in the first embodiment.

The operation of the image processing apparatus 10 in the fourth embodiment is as follows.

First of all, the map generating unit 14 generates a plurality of separability maps using a plurality of types of circular separability filter having different radii.

Then, the map generating unit 14 configures a three-dimensional separability map using a scale (radius) as a parameter for the two-dimensional separability maps.

Then, the image generating unit 16 uses the obtained three-dimensional separability to obtain the three-dimensional distance-transformed image.

Then, the image generating unit 16 generates a corresponding skeleton image.

Then, the output unit 18 outputs a three-dimensional skeleton image as shown in FIG. 9. It is also applicable to output the two-dimensional skeleton image obtained by projecting the same.

As described above, even the linear object having the width which cannot be obtained by a single radius is also extracted by generating the skeleton image on the basis of the separability maps of the plurality of different radii as in the image processing apparatus 10 in the fourth embodiment.

### (Modification)

The invention is not limited to the above described embodiments as is, and the components may be changed without departing the scope of the invention in the stage of implementation thereof.

Also, by combining the plurality of components disclosed in the embodiments shown above as needed, various modes of the invention are achieved. For example, some of the components may be eliminated from all the components shown in the embodiments.

Furthermore, the components presented in the different embodiments may be combined as needed.

A first modification will be described now.

In the embodiments described above, the skeleton image is generated by the distance-transformed image and generation of its skeleton. In contrast, the same output may be obtained by applying a thinning process to the separability map or the binarized separability map.

The thinning process is a process to thin the line width of a given geometric figure to extract a center line having a width of one pixel. Although various algorithms are proposed for thinning, the following process is basically performed.

First of all, all pixels which are able to be deleted from boundary points in the image (one pixel having at least one zero pixel in four-neighbor pixels) and which are not the end point of the line (for example, the number of the one pixel from among the eight-neighbor pixels is three or more) are deleted.

The process described above is repeated by raster scanning until there are no more pixels to be deleted.

The thinned image has such nature that the connectivity is stored unlike the skeleton image.

A second modification will now be described.

It is also possible to add a process such as binarization or noise elimination as needed in the course of the process of the image processing apparatus 10. For example, the noise is eliminated by adding the process such as dilation or erosion before generating the distance-transformed image.

A third modification will now be described.

The image processing apparatus 10 is applied to a case of being used for individual authentication such as in the ATM. However, the invention is not limited thereto, and may be applied to a medical image processing apparatus. For example, it may be applied to a case of detecting vessels such as vein or artery from X-ray images, MRI images, and angiographic images.

A fourth modification will now be described.

The image processing apparatus 10 employs the circular separability filter. However, the separability filter is not limited to the circular shape, and may be polygonal separability filters of square, pentagon, hexagon, and the like as long as equivalent extraction is achieved in any directions.

What is claimed is:

1. An image processing apparatus comprising:
a map generating unit configured to apply a separability filter to respective positions of an image including an inputted linear object, calculate separability of the respective positions, and generate a separability map as a set of the separability of the respective positions; and
an image generating unit configured to apply distance transform or thinning process to the separability map and generate a skeleton image in which the linear object is displayed; and
an output unit configured to output the skeleton image.

2. The apparatus according to claim 1, wherein the shape of the separability filter applied by the map generating unit is circle or polygon.

3. The apparatus according to claim 1, wherein the image generating unit performs the distance transform or the thinning process after binarizing the separability map.

4. The apparatus according to claim 1, wherein the map generating unit includes a plurality of the separability filters of different sizes or different shapes, generates separability maps corresponding to the respective separability filters from the image, and integrates the plurality of separability maps to generate a single separability map.

5. The apparatus according to claim 1, wherein the map generating unit includes a plurality of the separability filters of different sizes or different shapes, generates separability maps corresponding to the respective separability filters from the image, and the image generating unit generates skeleton images for the plurality of separability maps respectively.

6. The apparatus according to claim 1, wherein the map generating unit includes a plurality of the separability filters of different sizes, generates respective two dimensional separability maps corresponding to the respective separability filters from the image, and the image generating unit generates a three-dimensional skeleton image corresponding to the size of the separability file for the plurality of two-dimensional separability maps.

7. The apparatus according to claim 6, wherein the image generating unit projects the three-dimensional skeleton image to generate a two-dimensional skeleton image.

8. An image processing method comprising:
applying a separability filter to respective positions of an image including an inputted linear object, calculating separability of the respective positions, and generating a separability map as a set of the separability of the respective positions by a computer; and
applying distance transform or thinning process to the separability map and generating a skeleton image in which the linear object is displayed; and
outputting the skeleton image by the computer.

9. A program stored in a computer readable medium, the program implementing:
applying a separability filter to respective positions of an image including an inputted linear object, calculating separability of the respective positions, and generating a separability map as a set of the separability of the respective positions; and
applying distance transform or thinning process to the separability map and generating a skeleton image in which the linear object is displayed; and
outputting the skeleton image.
